(19) United States
(12) Patent Application Publication
(10) Pub. No.: US 2016/0031505 A1
(43) Pub. Date: Feb. 4, 2016

(54) Auto-extending stabilizer wheel system for a child's bicycle

(71) Applicant: Cheryl Feiock, Pierre, SD (US)

(72) Inventor: Cheryl Feiock, Pierre, SD (US)

(21) Appl. No.: 14/811,830

(22) Filed: Jul. 29, 2015

Related U.S. Application Data
(60) Provisional application No. 62/030,598, filed on Jul. 29, 2014.

(51) Int. Cl. B62H 1/12; G01C 23/00; B62D 37/06; B62H 1/06

(52) U.S. Cl. CPC B62H 1/12; B62H 1/06; G01C 23/00; B62D 37/06

(57) ABSTRACT

An auto-extending stabilizer wheel system for a child's provides a circular aperture, enabling the mounting of the wheel on the bicycle's rear axle or an existing structural bolt. Within the gearbox, a servomotor is provided and any one of several stabilizing mechanisms, to determine whether the bicycle is excessively tilting. A turn detection mechanism and a speedometer are installed on the front forks, to provide data to the gearbox on the angle and speed of a turn. A memory device retains a mobile application which stores data on safe, acceptable ranges of motion at different speeds. If the degree of tilt reaches an unacceptable range of motion at any time, the servomotor extends the wheel to provide stabilization. If the degree of tilt remains within 50 percent of the acceptable range of motion for the same pre-determined period of time, the wheel is retracted by the servomotor.

### CROSS-REFERENCE TO RELATED APPLICATIONS

This Application claims the benefit of U.S. Provisional Application No. 62/030598, filed Jul. 29, 2014, which is hereby incorporated by reference.

### STATEMENT REGARDING FEDERALLY SPONSORED RESEARCH OR DEVELOPMENT

Not Applicable

### PARTIES TO A JOINT RESEARCH AGREEMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to bicycle attachments and accessories and in particular to an auto-extending stabilizer wheel system for a child's bicycle. Training wheels for a child's bicycle are a time-honored rite of passage, but they have very serious limitations. Particularly in high traffic neighborhoods, the prospect of removing the training wheels for the first time is a source of apprehension and anxiety for any parent. Ideally, the training wheels would gradually become less and less available as the child becomes more and more steady and well-balanced while riding, and still be available during moments of unsteadiness or lack of confidence. But there only two options: either the child must use training wheels 100 percent of the time, or do without them 100 percent of the time. An auto-extending stabilizer wheel system for a child's bicycle, which normally remains in a retracted position but will detect whether the bicycle is tilting or wobbling and will instantly extend to the ground, would resolve this problem.

### SUMMARY OF THE INVENTION

Accordingly, the invention is directed to an auto-extending stabilizer wheel system for a child's bicycle. The gearbox of each wheel provides a circular aperture, enabling the mounting of the wheel on the bicycle's rear axle or an existing structural bolt. Within the gearbox, a reversible, battery-powered servomotor is provided. The gearbox also provides any one of several stabilizing mechanisms, such as a gyrostabilizer or a simple leveling mechanism, to determine whether the bicycle is excessively tilting or wobbling. A turn detection mechanism and a speedometer are installed on the front forks , to provide data to the gearbox on the angle and speed of a turn. A memory device retains a mobile application which stores data on safe, acceptable ranges of motion at different speeds. If the degree of tilt reaches 90 percent of the acceptable range of motion at any time, or 70 percent for a significant, pre-determined period such as five seconds, the servomotor extends the wheel to the ground to provide stabilization. If the degree of tilt subsequently remains within 50 percent of the acceptable range of motion for the same pre-determined period of time, the wheel is retracted by the servomotor.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWING

The accompanying drawing is included to provide a further understanding of the invention and is incorporated into and constitutes a part of the specification. It illustrates one embodiment of the invention and, together with the description, serves to explain the principles of the invention.

FIG. 1 shows a side perspective view of a stabilizer component of the first exemplary embodiment, displaying the gearbox 10, the aperture 11, the wheel mount 12, the coil spring 13, and the wheel 14.

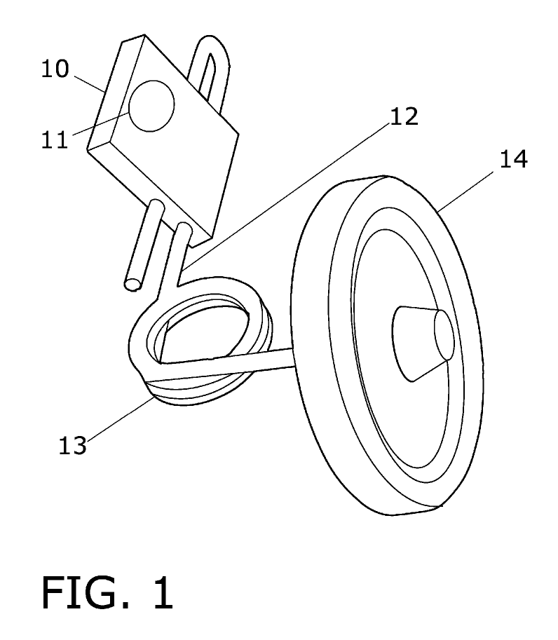

FIG. 2 shows a side view of a bicycle 30, displaying the stabilizer mechanism, the speedometer 23, the turn detection mechanism 21, the wires 20, the switch 22, the front fork 31, and the rear axil 32.

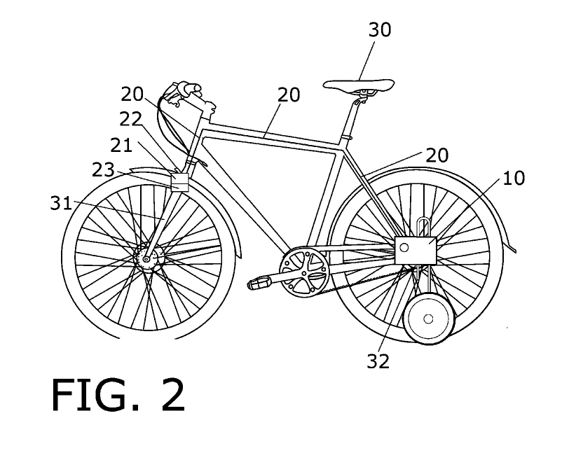

### DETAILED DESCRIPTION OF THE INVENTION

Referring now to the invention in more detail, the invention is directed to an auto-extending stabilizer wheel system for a child's bicycle 30.

The first exemplary embodiment provides four major components: a pair of stabilizers 10, a speedometer 23, and a turn detection mechanism 21. When installed, all four of the major components are connected by wires 20 to transmit electric power and data. An on/off switch 22 for all four major components of the system is provided. In one embodiment the switch is provided on the speedometer, such that it is within easy reach of the child user. The gearbox 10 of each stabilizer provides a circular aperture 11, enabling the mounting of the stabilizer on the bicycle's rear axle 32 or an existing structural bolt. Within the gearbox 10, a reversible, battery-powered servomotor is provided which is actuated electromechanically. To balance the weight, the battery pack for the system may be located in the gearbox 10 on one side, while the microprocessor and memory device are located in the gearbox 10 on the other side. Each gearbox 10 also provides any one of several types of stabilizing mechanisms, such as a gyrostabilizer or a simple leveling mechanism, to determine whether the bicycle 30 is excessively tilting or wobbling.

The turn detection mechanism and the speedometer are installed on the front forks 31, to provide data to the microprocessor on the angle and speed of a turn. Since a sharper turn and a greater degree of tilt can be safely handled at lower speeds, the combination of all these data sources is required. A memory device retains a mobile application which stores data on safe, acceptable ranges of motion at different speeds.

If the degree of tilt reaches 90 percent of the acceptable range of motion at any time, or 70 percent for a significant, pre-determined period such as five seconds, the servomotor operates the wheel mount 12 downward to extend the wheel 14 to the ground to provide stabilization. If the degree of tilt subsequently remains within 50 percent of the acceptable range of motion for the same pre-determined period of time, the servomotor reverses to operate the wheel mount 12 upward, retracting the wheel 14. The wheel mount 12 incorporates a coil spring 13 to provide a smoother, more stable ride for the child user.

To use the first exemplary embodiment, the child user mounts the bicycle 30, activates the on/off switch 22, and begins riding the bicycle 30. If the amount of wobble or degree of tilt exceeds the safe range of motion parameters established in the mobile application, the servomotors are actuated and the wheels 14 are extended to the ground to prevent a fall.

The gearbox 10, the wheel mount 12, the speedometer, and the turn detection mechanism are preferably manufactured from rigid, durable materials such as steel, brass, and aluminum. The wheels 14 are preferably manufactured from a rigid, durable material such as steel, providing solid tires which are preferably manufactured from a flexible, durable material such as rubber or silicone. The wires are preferably manufactured from braided copper alloy wire sheathed in plastic. Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. An auto-extending stabilizer wheel system, comprising:
(a) a pair of stabilizers;
(b) said stabilizers further comprising a gearbox, a wheel mount, and a wheel;
(c) said gearbox further comprising: a circular aperture, a servomotor, a battery pack, and a stabilizing mechanism;
(d) said circular aperture being configured for mounting said gear box onto a bicycle;
(e) said servomotor being electronically powered by said battery pack;
(f) said servomotor being in mechanical connection with said wheel mount;
(g) said servomotor and said wheel mount being configured such that said servo motor lifts and raises said wheel mount when activated;
(h) a speedometer;
(i) a turn detection device;
(j) said gearbox, said speedometer, and said turn detection device being physically connected by wires;
(k) said gearbox, said speedometer, and said turn detection device being in electronic communication with one another;
(l) said speedometer measuring the speed of said bicycle and communicating speed to said gearbox;
(m) said turn detection device measuring the turn angle of said bicycle and communicating turn angle to said gearbox;
(n) said gearbox being configured to activate said servomotor and lower said wheel mount when the tilt of said bicycle exceeds a predetermined level of tilt;
(o) said predetermined level of tilt being based on the bicycles speed, turn angle, and time;
(p) said gearbox being configured to activate said servomotor and raise said wheel mount when the tilt of said bicycle is within said predetermined level of tilt for a predetermined period of time;
(q) said predetermined period of time being based on the bicycles speed and turn angle.

2. The auto-extending stabilizer wheel system of claim 1, wherein said wheel mount further includes a coil spring.

3. The auto-extending stabilizer wheel system of claim 1, wherein said gearbox is mounted to a rear axil of said bicycle.

4. The auto-extending stabilizer wheel system of claim 2, wherein said gearbox is mounted to a rear axil of said bicycle.

5. The auto-extending stabilizer wheel system of claim 1, wherein said servomotor is configured to lower said wheel mount until said wheel touches the ground.

6. The auto-extending stabilizer wheel system of claim 2, wherein said servomotor is configured to lower said wheel mount until said wheel touches the ground.

7. The auto-extending stabilizer wheel system of claim 1, wherein said speedometer is attached to the front fork of said bicycle.

8. The auto-extending stabilizer wheel system of claim 2, wherein said speedometer is attached to the front fork of said bicycle.

9. The auto-extending stabilizer wheel system of claim 1, wherein said turn detection device is attached to the front fork of said bicycle.

10. The auto-extending stabilizer wheel system of claim 2, wherein said turn detection device is attached to the front fork of said bicycle.

11. The auto-extending stabilizer wheel system of claim 1, further comprising a switch; said switch being in electronic communication with said gear box; said switch being configured to activate power to said gearbox.

12. The auto-extending stabilizer wheel system of claim 2, further comprising a switch; said switch being in electronic communication with said gear box; said switch being configured to activate power to said gearbox.

13. The auto-extending stabilizer wheel system of claim 7, further comprising a switch; said switch being in electronic communication with said gear box; said switch being configured to activate power to said gearbox; said switch being attached to said speedometer.

14. The auto-extending stabilizer wheel system of claim 8, further comprising a switch; said switch being in electronic communication with said gear box; said switch being configured to activate power to said gearbox; said switch being attached to said speedometer.

15. The auto-extending stabilizer wheel system of claim 1, wherein said servomotor is actuated electromechanically.

16. The auto-extending stabilizer wheel system of claim 2, wherein said servomotor is actuated electromechanically.

17. The auto-extending stabilizer wheel system of claim 1, wherein said stabilizing mechanism is one of a gyrostabilizer or a leveling mechanism.

18. The auto-extending stabilizer wheel system of claim 2, wherein said stabilizing mechanism is one of a gyrostabilizer or a leveling mechanism.
